(19) United States
(12) Patent Application Publication
(10) Pub. No.: US 2014/0278835 A1
(43) Pub. Date: Sep. 18, 2014

(54) SYSTEM AND METHOD FOR RECORDING AND ANALYZING OPINIONS

(71) Applicant: Alexander J. Moseson, Havertown, PA (US)

(72) Inventor: Alexander J. Moseson, Havertown, PA (US)

(21) Appl. No.: 14/210,506

(22) Filed: Mar. 14, 2014

Related U.S. Application Data
(60) Provisional application No. 61/788,872, filed on Mar. 15, 2013.

(51) Int. Cl. G06Q 50/00; G07C 13/00

(52) U.S. Cl. CPC G06Q 50/01; G07C 13/00
USPC 705/12

(57) ABSTRACT

A method includes electronically receiving a first statement from a first user; electronically publishing the first statement; allowing a second user to electronically vote an opinion regarding the validity of the first statement; and receiving a second statement from the first user, the second statement and the first statement forming an argument. A non-transitory machine-readable storage medium, having encoded thereon program code, wherein, when the program code is executed by a machine, the machine implements the method is also provided.

### CROSS-REFERENCE TO RELATED APPLICATION

This application claims priority from U.S. Provisional Patent Application Ser. No. 61/788,872, filed on Mar. 15, 2013, which is incorporated herein by reference in its entirety.

### FIELD OF THE INVENTION

The present invention relates to recording and analyzing opinions of statements and/or arguments based on the statements.

### BACKGROUND OF THE INVENTION

Today's society incorporates numerous social media outlets that allow a user to make comments or voice opinions and to electronically disseminate those comments or opinions to a worldwide audience. While other users can agree, disagree, or otherwise comment on the original comment, opinion, or other content or topic, these social media outlets do not provide any structured format that allows the interweaving of opinions or comments to form arguments. This makes participation in such discussions, or the analysis thereof, difficult.

There exists a need to provide a social media format that allows users to generate statements and arguments based on a plurality of statements regarding which users can vote their opinion, yet still engage in free-form discussion should they so choose.

### BRIEF SUMMARY OF THE INVENTION

Briefly, the present invention provides a method of electronically receiving a first statement from a first user; electronically publishing the first statement; allowing a second user to electronically vote an opinion regarding the validity of the first statement; and receiving a second statement from the first user, the second statement and the first statement forming an argument.

Additionally, a non-transitory machine-readable storage medium, having encoded thereon program code, wherein, when the program code is executed by a machine, the machine implements the method is also provided.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is an exemplary graphical user interface (“GUI”) of a homepage of the website according to the present invention;

FIG. 2A is an exemplary GUI allowing the user to input a statement into the system of the present invention;

FIG. 2B is a Venn diagram showing the relationships between a statement, an argument, a conclusion, a premise, and a discussion thread, as used herein;

FIG. 2C is a Venn diagram showing the relationship between a statement, a comment, and a discussion thread, as used herein;

FIG. 3A is an exemplary GUI allowing the user to input an argument into the system of the present invention;

FIG. 3B is an exemplary GUI allowing the user to select privacy settings for the system of the present invention;

FIG. 3C is an exemplary GUI allowing the user to preview and post an argument into the system of the present invention;

FIG. 4 is an exemplary GUI allowing the user to add comments to a statement/argument in the system of the present invention;

FIG. 5 is an exemplary GUI of a posted comment to the system of the present invention;

FIG. 6 is an exemplary GUI illustrating listings of posted comments to the system of the present invention;

FIG. 7A is an exemplary GUI illustrating search results in the system of the present invention;

FIG. 7B is an exemplary GUI illustrating a Custom Report Generator used in the system of the present invention;

FIG. 8A is an exemplary GUI illustrating a user's homepage used in the system of the present invention;

FIG. 8B is an exemplary GUI illustrating a user's “Find Users” page used in the system of the present invention;

FIG. 9 is an exemplary GUI illustrating a user's profile editing page used in the system of the present invention;

FIG. 10 is an exemplary GUI illustrating a plurality of metrics for a group's profile information used by the system of the present invention;

FIG. 11 is an exemplary GUI illustrating pie charts of users' votes on a particular statement or argument based on gender;

FIG. 12 is an exemplary GUI illustrating a bar graph of users' votes on a particular statement or argument based on geographical location;

FIG. 13 is an exemplary GUI illustrating a line graph of users who agree or disagree with a particular statement or argument over time;

FIG. 14 is an exemplary schematic drawing of the system according to the present invention; and

FIG. 15 is a flowchart illustrating an exemplary operation of the system of the present invention.

### DETAILED DESCRIPTION OF THE INVENTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

The present invention provides an electronic social media context to allow users to provide and discuss topics of interest. The invention may be provided in the form of a website that provides a framework for generating topics and comments based loosely on philosophical arguments, which provide a conclusion along with reasons in support of the conclusion. Additionally, the invention allows users to vote on the content, quality, and/or logic of arguments. The present invention could also be integrated into an existing website.

Referring to exemplary graphical user interface (“GUI”) 100 shown in FIG. 1, an exemplary homepage 102 for system 100 for providing the inventive electronic social media context is shown. Homepage 102 allows a user to click on a “Make A Statement” button 104, which generates exemplary GUI 200 shown FIG. 2A. Statement box 204 allows the user to electronically enter a text string that forms statement 201. In an exemplary embodiment, a maximum of 160 text characters may be used, although those skilled in the art will recognize that more or less than 160 text characters may be allowed. As shown in FIG. 2B, a “statement” is a declarative text string submitted by a user. Further, an “argument” is a plurality of statements with one or more premises leading to a conclusion. A “topic” is a statement or an argument. A “premise” is a statement supporting an argument. A “conclusion” is a statement which one or more premises has led to. A “comment” is content submitted by a user in response to a topic. A “discussion thread” is a plurality of related comments on a topic. In an alternative embodiment, shown in FIG. 2C, a discussion thread can be a statement and a comment.

Referring back to FIG. 2A, if the user is relying on another source for the statement, a Reference block 206 is provided that will allow the user to type in the reference source for the statement. Additionally, if the reference source is a website, a Reference URL block 208 is provided to allow the user to input the website address where the reference may be located.

After the user has input the desired statement in statement box 204, the user clicks on “Next” button 212 in order to electronically publish the statement to system 100. A statement is considered to be published by printing the statement electronically onto an electronic viewing screen (whether privately available or publicly displayed) or printing the statement/argument on paper. If the user desires to cancel the process and return to home page 102, the user clicks on “Cancel” button 216.

After the user clicks on “Next” button 212, GUI 300, shown in FIG. 3A, is displayed. GUI 300 includes a plurality of text boxes 302-306 that allow the user to submit additional statements as part of the argument.

If the user desires to add additional premises, the user can click on “Add Another Premise” button 310, which will generate an additional text box similar (not shown) to text boxes 302-306. If the user desires to submit only a statement (not an argument) and proceed to exemplary GUI 330, the user can click on “Skip” button 315. If the user desires to cancel any input prior to submitting, the user can click on “Cancel” button 312. If the user desires to return to GUI 200, the user clicks on the “Back” button 314. After the user has submitted all of the premises in support of his/her argument, user clicks on a “Next” button 316.

While the user is submitting statements in boxes 204 or 302-306, if the text of the statement is similar to any prior statements submitted by the user or any other user, system 100 will automatically suggest the use of the existing statement instead of the creation of a new one. If the user selects the suggested prior statement, that statement will become a hyperlink that, if clicked on, jumps the user to the original statement as well as the entire discussion thread associated with that statement.

Clicking on the “Next” button 316 generates exemplary GUI 330, shown FIG. 3B, which lists a column 332 of potential categories into which the user can categorize his/her statement or argument. A “Privacy Options” feature 334 allows the user to determine privacy settings for the statement or argument. If the user desires to cancel any input prior to submitting, the user can click on “Cancel” button 336. If the user desires to return to GUI 300, the user clicks on the “Back” button 338. After the user has selected a category for his/her statement or argument, along with desired privacy settings, the user clicks on a “Next” button 340, which generates GUI 350, shown FIG. 3C.

FIG. 3C displays an argument that contains a conclusion 352 along with a plurality of premises 354, or a single statement if the user has chosen to skip creating an argument. If the user desires to cancel the statement or argument prior to submitting, the user can click on “Cancel” button 356. If the user desires to return to GUI 330, the user clicks on the “Back” button 358. If the user desires to post the statement or argument, the user clicks on “Submit” button 360.

Clicking on the “Submit” button 360 generates GUI 400, shown FIG. 4. FIG. 4 displays the conclusion to the argument as an argument title 402, along with the date that the argument was posted, the name of the author, and voting statistics.

If the user decides to add a new statement or argument, the user can click on “Make A Statement” button 403, which generates GUI 200, shown in FIG. 2A.

If the user or second user desires to comment on the statement or argument, that user can add a comment in a “Comments” box 410. Prior to being able to add a comment, however, the user must vote on whether they agree with the validity of the statement/argument embedded in argument title 402 by pressing an “Agree” button 409, whether they disagree by pressing a “Disagree” button 411, or currently have no opinion on the statement/argument by pressing an “Undecided” button 413. If the user attempts to add comment without voting first, a pop-up box (not shown) appears on GUI 400 that instructs the user to vote prior to adding a comment.

By agreeing or disagreeing with the validity of a statement/argument, the user is not necessarily stating whether they like or dislike the statement/argument. For example, it is possible to like a statement/argument even though the user disagrees with its validity. An argument, for example, may be written as a haiku or in iambic pentameter, leading a user to like the argument for its form, but still disagree with its validity. Alternatively, it is possible to dislike a statement/argument even though the user agrees with its validity. An argument, for example, can be made in defense of eating red meat while the user, who may be vegetarian, may dislike the argument but concedes that it is, in fact, a valid argument.

If a system moderator determines that a particular statement or argument is invalid or is a logical fallacy, the moderator can “flag” that statement or argument as such. Such flagging can be an internal flag such that the system moderators can see the flag. Alternatively, such flagging can be a public flag such that all users can see the flag and also optionally comment or vote on the flag. Optionally, the moderator also may be able to remove the argument from public view or modify the argument to remove any invalid or logically false statements.

Alternatively, the flag could be generated by a calculation on metrics including the validity votes of a plurality of users, such as, for example, a statement or argument with votes of “invalid” above a predetermined threshold (e.g. 75%). A more detailed discussion of flagging and related metrics and algorithms is provided later herein.

If any user desires to see statistics relating to a statement/argument, the user can press a “Statistics” button 415 that displays statistics relating to the statement/argument. A more detailed discussion regarding the statistics relating to a statement/argument is provided later herein.

For statements on which the user has voted, current vote tallies are displayed, the vote of the user is indicated by an inverted (e.g., reverse contrast) button as in 413 and, if a sufficient number of votes have been received, statistics button 415 is enabled. For statements on which the current user has not yet voted, current vote tallies are not displayed and the statistics button 415 is disabled.

A listing of “Related Arguments” 416 and a listing of “Related Statements” 418 are also provided to allow the user to view and vote on other related statements and arguments.

Prior to adding a comment, the user can click on “Preview” button 407, which generates a preview of the comment (not shown) that the user can then close. After that user has is satisfied with the comment that user can click on a “Save Comment” button 412, which then electronically publishes the comment in association with the original statement/argument as comment 502 in exemplary GUI 500, shown FIG. 5. If any user, including the first user, the second user, or a third user, believes that comment 502 is worth reading, that user clicks on a “Worth reading” button 504. If that user believes that comment 502 is not worth reading, that user clicks on a “Not worth reading” button 506. Similar to the distinction between “agree/disagree” versus “like/dislike” as discussed above, users do not necessarily need to agree or disagree, like or dislike, a comment to vote that it is worth or not worth reading.

Any of the prior users or any additional users may add additional comments in a comment box 510 to form or expand a discussion thread regarding the original statement or argument. If the user desires to read one or more postings, which include statements, arguments, and comments, the user may click on “Home” button 512 to return to home page 102, shown FIG. 1.

Referring back to FIG. 1, if the user clicks on “Browse” button 106, exemplary GUI 600, as shown in FIG. 6, is generated. GUI 600 displays a “Top Arguments” list 602 that displays the most popular arguments based on calculations on the total number of ratings (agree, disagree, or neutral) provided by users, and other data. The user may limit the category of the content shown using the “Choose A Category” drop-down box 601. A “Most Worth Reading” list 604 displays the statement/arguments that have been voted the most worth reading. A “Top Statements” list 606 displays the most popular statements based on calculations on the total number of ratings (agree, disagree, or neutral) provided by users, and other data. A “Most Controversial” list 608 lists the most controversial arguments by dividing the number of users who agree with the argument by the number of users who disagree with the argument and listing the arguments whose quotient is closest to the number “1”. Consideration may also be given to the total number of votes. A “Most Active Contributors” list 610 lists the users who are most active in providing statement/arguments/comments and/or ratings for system 100. A more detailed discussion of such metrics and algorithms is provided later herein.

An argument listing and its associated data is provided in block 612. The statements may be listed according to several filters including, chronologically, reverse chronologically, top rated, controversy rating, and popularity rating. The listing shown in FIG. 6 is sorted according to chronological order, which is based on timestamp, which is displayed above conclusion 402, shown FIG. 4. In an exemplary embodiment, a selected filter 613 is “Oldest First”. A time delay precludes the viewing of statement/argument/comments that are less than a predetermined age (i.e., 15 min.) in order to allow the user who posted that statement/argument/comment to edit or delete his/her posting.

A “Make A Statement” button 614 is provided to allow a user to submit a new statement or argument. Clicking on button 614 generates exemplary GUI 200, shown FIG. 2A.

Referring back to FIG. 1, “Top Arguments” list 602, “Most Worth Reading” list 604 and “Top Statements” list 606 are replicated on homepage 102 to encourage the user to review these arguments/statements and to encourage further discussion. If the user does not desire to view any of these arguments/statements, the user can type in search parameters in a search block 108, which will then generate exemplary GUI 700, shown in FIG. 7A.

GUI 700 displays search results in a “Search results” column 702 that includes statements and comments having the word(s) typed into search block 108 from which the user can select to read and/or comment on. If the user desires to narrow his/her search, the user can add new search words in search box 704 and click on “Search” button 706 to generate new results. Alternatively, user can specify additional search criteria in the “Advanced Search” fields 708. If a user desires to generate detailed reports on metrics, he/she may click “Go To Custom Report Generator” button 710, which generates GUI 750 in FIG. 7B.

FIG. 7B displays a plurality of selection boxes 752-776 that allow the user to generate a report based on the parameters listed in boxes 752-776. After the user has selected the desired parameters, the user clicks on “Generate The Report!” Button 778, which generates metrics (not shown) on votes or other data, displayed in formats comprising figures, tables, downloadable data files, multi-component reports or other formats.

Referring back to FIG. 7A, if the user does not desire to read any of these posts (e.g., statements, arguments, comments) or generate a custom report, the user can click on “Home” button 512 to return to GUI 100, shown FIG. 1.

Referring back to GUI 100, shown in FIG. 1, a user can click on their username 112, which generates an exemplary GUI 800 of the user's profile, shown FIG. 8A. FIG. 8A provides information about the user, including the use of history with respect to system 100. An “Online” indicator 802 indicates whether the user is online. Other information available through GUI 800 includes any posts that the user has made by clicking buttons 804, 806, or 808; votes the user has cast by clicking “Votes” button 810; any blog entries (created and managed by each user through another sub-system, not shown) that the user has made by clicking “Blog” button 812; the friends that the user has by clicking on “Friends” button 814; and any groups within system 100 that the user has joined by clicking on “Groups” button 816.

Because the user is viewing his/her own profile, the “Add As Friend” button 818 is disabled. The user can find others users, including existing and potential new friends, by clicking on “Find a Friend” button 820, which generates GUI 850, shown in FIG. 8B.

A GUI 850 allows the user to find people who have similar or dissimilar voting interests. To specify search criteria, the user can click on desired boxes in “Find Users By Votes” box 852. Results are displayed in box 853, categorized as friends with similar votes in box 840, friends with dissimilar votes in box 842, all users (not just friends) with similar interests in box 844, and all users (not just friends) with dissimilar interests in box 846. Alternatively, if the user knows another user's e-mail address, the user can type the e-mail address into box 854. Still alternatively if the user knows another user's username, the user can type the username into box 856. Further, the user can type in a postal or zip code into box 858 to find friends within that geographic vicinity. Additionally, the user can find friends from other sources, such as for example Facebook, Twitter, etc. by clicking an appropriate button in box 860.

Referring back to GUI 800 in FIG. 8A, the user can click on an “Edit User Profile” link 822, which generates GUI 900, shown FIG. 9. GUI 900 includes a plurality of metrics 902-920 that include boxes for the user to provide answers to exemplary questions about metrics such as gender, sexual orientation, religion, race, internet experience, occupation, income level, political views, country, and postal code. Each of the plurality of metrics 902-918 provides only a selection from a predefined list of responses so that graphs, charts, or other demonstrators can be generated according to each of the predefined lists. For each of the plurality of metrics 902-926, the user may also indicate privacy settings, controlling which sets of other users can view each metric by clicking on an appropriate button 940, 942, and 944, respectively: public (all), friends (friends only), or private (none). While these are exemplary metrics, those skilled in the art will recognize that additional or alternative metrics or data types can be used.

Additionally, the user is able to choose and upload photographs by clicking on the “Choose File” button 922; input contact information in “Full Name” block 924 and “E-mail Address” box 926; and add personal information about themselves in an “About Me” summary block 928. After the user has finished selecting desired metrics and inputting desired information, the user can click on “Save Profile” button 932 ro save information to system 100.

Referring back to GUI 100 and FIG. 1, a user may click on the photo or name of a different (target) user link 113 to generate GUI 800 in FIG. 8A for the target user. For Statements 804 and Arguments 806, the target user's votes appear in a circle around a check mark (agree with the statement/argument) or in a circle around an “x” (disagree with the statement/argument). For comments 808 the target user's votes appear in a circle around a thumbs up (comment is worth reading) or in a circle around a thumbs down (comment is not worth reading). Because the current user does not own the target user's profile, “Edit User Profile” button 822 is disabled. The current user may click “Add as Friend” button 818 to add the target user as a friend.

Referring back to GUI 100 and FIG. 1, a “Dashboard” link 114 generates GUI 800, shown FIG. 8A; a “Read” link 116 generates GUI 600, shown in FIG. 6; a “Search” link 118 generates a search box similar to search box 704 in FIG. 7A that allows the user to input keywords to search for existing statements and arguments including the entered keywords.

Clicking on “Groups” link 120 generates an advanced search box (not shown), similar to advanced search box 708 in FIG. 7A, that allows the user to type in the name of a group, a keyword, or click on a subject box to generate a list of groups from which to select. Clicking on a group name generates GUI 1000, shown FIG. 10, which lists the name and short description 1020 of a Group. GUI 1000 includes a “Join this Group” button 1010 to allow user to click on to join the group. Also available in box 1030 is a status and history of the group with respect to system 100, any blog entries that the group has made, and a history of the group's recent comments to arguments/statements made in system 100. Group profile information may be edited by group managers in a GUI similar to that of GUI 900, shown in FIG. 9, adapted for groups instead of individuals.

Using buttons 1002-1008 in box 1018, user may join the group in one of four modes: i) “Adopt all votes (keep linked),” wherein the user's account will be continuously updated with all of the agree/disagree votes that the group has, ii) “Adopt all votes (only one time)”—wherein the user's account will be updated one time with the current agree/disagree votes that the group has, iii) “Let me choose votes to adopt”—wherein the user can choose which of the group's agree/disagree votes to adopt one time, and iv) “Don't adopt any votes”—wherein the user does not adopt any of the group's agree/disagree votes. Groups may be managed in one of two modes: i) an individual account, wherein a single account determined the votes and other activity of the group or ii) a democratic group, wherein the votes of the group's members determine the votes of the group, for example by a simple majority.

Manager 1012 allows users to see who is managing this group, and allows users to contact the Manager via message through system 100. Also, the number of Group members 1014 and the number of Posts 1016 are displayed on GUI 1000, letting users know how popular and/or active the particular Group is.

System 100 may also incorporate features not specifically shown as figures.

Key words in each discussion thread such as, for example, nouns, may be electronically “tagged” with other descriptors to allow comparison and publishing, or cross-posting, with other discussion threads. For example, the term “pork chop” may be tagged with key words or phrases such as, for example: pig, meat, and bone. The word “steak” may be tagged with key words or phrases such as, for example: cow, meat, and bone. The word “bacon” may be tagged with key words or phrases such as, for example: pig, meat, breakfast, and boneless.

A topic or discussion thread that includes the term “pork chop” may be cross-posted with a different topic or discussion thread that includes the word “steak” because both products are meat products and both can contain bones. Additionally, the topic or discussion thread that includes the term “pork chop” may also be cross-posted with yet another different topic or discussion thread that includes the word “bacon” or “pork tenderloin” because both are meats that come from pigs. On the other hand, a topic or discussion thread that includes the words “steak” may not necessarily be cross-posted with the topic or discussion thread that includes the terms “bacon” or “pork tenderloin” because the only common tag between the two terms is the term “meat”. The single commonality of the term “meat” may not necessarily be sufficient to warrant cross-posting. Those skilled in the art, however, will recognize that system 100 can be developed such that the single commonality is sufficient to warrant cross-posting, depending on how much cross-posting is desired.

Tagging of each key word may be done manually by the user while generating the statement, argument, or comment. Alternatively, a database may be provided that includes a plurality of associated words such that, each time one of those words is used in generating a statement, argument, or comment, that word is automatically tagged with its associated words. Still alternatively, system 100 can automatically add a new tag as new words are associated with previous tags in an application of machine learning. Still further, those skilled in the art will recognize that other methods of tagging may be used.

While the use of tags associated with words in a topic or discussion thread may be used to automatically cross-post one topic or discussion thread with another, in an alternative and/or an additional method, a moderator may manually cross-post topics or discussion threads.

Discussion threads formed arguing that eating steak is bad because eating excessive red meat can lead to health issues and that eating pork chops is bad because undercooked pork can lead to diseases can be merged together into a new discussion thread that incorporates both the “steak” and the “pork chop” discussion threads.

The topics and discussion threads generated by the users can be analyzed in different ways to determine mindsets of the users and, by extrapolation, with a sufficient data set, of society as a whole, or subsets thereof. The data can be manipulated to determine controversial and/or popular topics and discussion threads, flags on validity (or the lack thereof), relationships between statements and arguments, including relationships not explicitly made by users, and trends, among other things.

Additionally, the data can be manipulated to provide targeted advertising to the users. For example, a particular user whose statements, arguments, and comments tend to demonstrate that the user is a carnivore may be targeted with advertising to purchase beef products, while a particular user who statements, arguments, and comments tend to demonstrate that the user is a vegetarian may be targeted with advertising to purchase tofu. A user's profile metrics, such as metrics 902-920 can also be used to develop targeted advertising. Further, the profile metrics can be agglomerated to determine generalized profiles of the users that can be used by businesses to help determine trends. For example, in a discussion thread regarding the purchase of new automobiles, if metrics indicate that persons living in the U.S. above a certain latitude tend not to buy new automobiles between December-February (presumably due to cold weather), and automobile company may focus advertising during that timeframe to persons living in the U.S. below that latitude.

Further, a user's plurality of votes can be assessed by system 100 in order to provide recommendations to the user as to how the user should change existing votes or make new votes.

In one embodiment, if a user agrees with all premises of a valid argument and the argument is not flagged as invalid, system 100 could suggest to the user that the user vote that argument as being “valid”. In a second embodiment, system 100 can identify mutually exclusive statements or arguments and a recommendation to change a vote on one or more to avoid the logical conflict could be recommended. For example, a user should not simultaneously agree with the statements “All food should be vegan” and “All food should contain bacon.” In a third embodiment, system 100 can make suggestions about statements and arguments for which the user has not yet voted. For example, the user could be viewing the statement “Nuclear power stations should no longer be built,” or otherwise search for statements or arguments related to nuclear power, and a recommendation could be made on how a person should vote.

Additionally, system 100 can automatically generate metrics such as, for example, time stamping each statement, argument, and comment entry. Further, external metrics, such as for example the latest winner of the Super Bowl, the political party of the current president, the value of the Dow Jones Industrial Average, or other metrics can also be incorporated into system 100.

In general, metrics can be a data point, such as, for example, the user's age, a timestamp, or the political party of the current president. Additionally, metrics can be calculations based on a plurality of data points.

Such algorithms, combining internal and external metrics, and may employ and advance elements of fields including, but not limited to, propositional logic (also known as sentential logic), first-order logic, fuzzy logic, heuristics, modal logic, Bayesian networks, automated reasoning, rules of inference, natural language processing, semantic networks, neural algorithms, genetic algorithms, deductive databases, logic programming, commonsense reasoning, and/or artificial intelligence. The algorithms may be improved over time, and the data generated by system 100 would be uniquely valuable to the advancement of the above fields and for direct application such as in advertising. Embodiments of such fields are discussed, for example, in Barber, D. 2012. “Bayesian Reasoning and Machine Learning”: Cambridge University Press; Vas, P. 1999. “Artificial-Intelligence-based Electrical Machines and Drives: Application of Fuzzy, Neural, Fuzzy-neural, and Genetic-algorithm-based Techniques”: OUP Oxford; and McCarthy, J. 1989. “Artificial intelligence, logic and formalizing common sense. Philosophical logic and artificial intelligence,” 161-190, which are all incorporated herein as though fully set forth.

The following arguments [A]-[J] are examples of different types of arguments that may be made within the system 100. Each line is a statement [numbered 1, 2, 3], and each set is an argument [lettered A, B, C]. These examples do not necessarily represent the views of the inventor or others associated with this document.

[A] Cats are better than dogs [1] (conclusion)

BECAUSE (premise)

Cats are low maintenance [2]

You don't need to walk cats [3]

It's great when cats try to catch laser pointers [4]

Cats are cuddly [5]

Cats are less expensive to keep than dogs [6]

[B] Dogs are better than cats [7]

BECAUSE

Dogs are more loyal than cats [8]

Dogs can play fetch [9]

Dogs don't tear up furniture as much as cats [10]

Dogs can be trained more easily than cats [11]

[C] Cats make good pets for the elderly [12]

BECAUSE

The elderly need low maintenance pets [13]

The elderly aren't as mobile as they used to be [14]

The elderly have low incomes [15]

Cats are low maintenance [2, same as used in argument A]

You don't need to walk cats [3, same as used in argument A]

Cats are less expensive to keep than dogs [6, same as used in argument A]

[D] Marijuana should be legalized in the US [16]

BECAUSE

Marijuana is no more harmful than legal drugs like alcohol [17]

Marijuana trafficking currently supports organized crime [18]

Marijuana could be a source of tax revenue [19]

[E] Marijuana should not be legalized in the US [20]

BECAUSE

Marijuana is more harmful than legal drugs like alcohol [21]

Marijuana is a gateway to harder drugs [22]

Marijuana makes people lazy [23]

[F] Men should be responsible for taking the trash out [24]

BECAUSE

Taking out the trash requires someone physically strong [25]

Men are physically stronger than women [26]

Trash is smelly [27]

Men don't mind smells as much as women [28]

Sometimes it's cold outside when you have to take out the trash [29]

Men don't mind being cold as much as women [30]

It's traditional [31]

[G] Rich nations should help poor nations primarily by giving them money [32]

BECAUSE

Those who are financially well off have a moral obligation to help those who are not [33]

Rich nations can afford to give money to poor ones [34]

It is in the best interest of rich nations to make poor ones stable [35]

Nations with more money are more stable [36]

Money solves most problems [37]

Helping poor nations in ways other than giving money (e.g. giving food) doesn't work [38]

[H] The Philadelphia Eagles will win the 2014 Super Bowl [39]

[Example of invalid argument. Each premise statement may be true, but the premises don't lead to the conclusion]

BECAUSE

The Eagles have never won the Super Bowl [40]

The Phillies won the World Series in 2008 [41]

I'm an Eagles fan [42]

[I] You should give 10% of your income to the needy [43]

BECAUSE

Jesus commanded it [44]

Jesus' teachings are wise, even for non-Christians [45]

God loves a cheerful giver [46]

God will provide for all your needs [47]

[J] You should give 10% of your income to the needy [43, same as in argument I]

[Example of a valid but not sound argument. The premises lead to the conclusion, but the last premise is false.]

BECAUSE

Those who are financially well off have a moral obligation to help those who are not [33, as in G]

Most can give 10% of their income with little impact on their own lives [48]

If every American gave 10% of their income, it would total $1.3 trillion [49]

All of America's problems would be solved by donations of $1.3 trillion per year [50]

As discussed above, if the user desires to view statistics relating to a statement or argument, the user can press “Statistics” button 415 which generates GUI 1100-1300, shown FIGS. 11-13. The headings along the tops of each of FIGS. 11-13 correspond to the headings for buttons 902-920 from GUI 900 in FIG. 9. FIG. 11 shows a GUI 1100 that discloses pie charts showing statistics based on gender regarding “agree” (pie portion 1102), “disagree” (pie portion 1104), and “no opinion” (pie portion 1106). Such exemplary statistics demonstrate a trend indicating that men tend to agree with the particular statement/argument, while women tend to disagree with a particular statement/argument. An aggregate pie chart 1108 shows the percentage of “agree”, “disagree”, and “no opinion” votes for all voters.

FIG. 12 shows a GUI 1200 that discloses a bar chart 1208 showing statistics of votes agreeing with a statement or argument based on age. Such exemplary statistics demonstrate a trend indicating that people aged 30 and 80 increasingly agree with a particular statement/argument. Additionally, bar chart 1208 demonstrates that those aged 13-29 agree with the particular statement/argument at a percentage higher than that of those aged 30-49.

GUI 1300 in FIG. 13 shows a line graph of Agree/Disagree votes over a period of time. This particular exemplary graph demonstrates how, over time, less people tend to disagree with a particular statement/argument than at an earlier point in time.

While a pie chart, a bar chart, and line graph are shown in FIGS. 11-13, respectively, those skilled in the art will recognize that other type of charts may be used instead of or in addition to those illustrated.

It is desired that users must vote an opinion of a statement/argument before being allowed to view the statistics. If the user attempts to view the statistics part of voting, system 100 will generate a notification informing the user that the user must vote first. Only after a particular statement or argument has a predetermined number of votes, such as, for example 20 or more, and there is sufficient data to honor the privacy choices of the voters, will the “Statistics” voting button 415 (shown FIG. 1) be activated.

In an exemplary embodiment, statistics or metrics, such as the momentum, the controversy, the popularity (including recent popularity), and the rating value of a discussion thread can be normalized and given numerical ratings according to the following formulas.
1. Number of Agree Votes: (Number of agree votes)
2. Number of Disagree Votes: (Number of disagree votes)
3. Total Agree(A)/Disagree(D) Votes: [Agree]+[Disagree]
4. Recent Votes: Number of votes in the last five days
5. Momentum Rating (Scale of 0-10): 10×[Recent/Total]
6. Controversy Rating (Scale of 0-10): 10×[1-2ABS(Agree/Total-0.5)]
7. Popularity Rating: 10×[TotalA/DVotes/MaxTotalVotesBelowThreshold] where MaxTotalVotesBelowThreshold=the highest number of total A/D votes below Average+1.5×STDEV for the total number of votes cast
8. Recently Popular (Scale of 0-10): 0.5×Momentum Rating+0.5×Popularity Rating
9. Top Rating (Scale of 0-10): 0.2×Momentum Rating+0.4×Controversy Rating+0.4×Popularity Rating

The date of each vote 409, 411, 413 in FIG. 4 provides the date of each vote, which is used to determine whether a vote is to be classified as a “Recent Vote”. The Recently Popular and Top Rating values are weighted averages of the ratings used these values. Fictitious exemplary values for 10 discussion threads are provided below in table A.

TABLE A

| | Votes Cast | | | | Derived Ratings | | | Weighted Ratings | |
|---|---|---|---|---|---|---|---|---|---|
| | | | A/D | | Momentum | Controversy | Popularity | Recently | Top |
| | Agree | Disagree | Total | Recent | Rating | Rating | Rating | Popular | Rating |
| 1 | 267 | 231 | 498 | 359 | 7.2 | 9.3 | 10.0 | 8.6 | 9.1 |
| 2 | 856 | 1399 | 2255 | 1872 | 8.3 | 7.6 | 10.0 | 9.2 | 8.7 |
| 3 | 196 | 245 | 441 | 218 | 4.9 | 8.9 | 8.8 | 6.9 | 8.1 |
| 4 | 148 | 350 | 498 | 256 | 5.1 | 5.9 | 10.0 | 7.6 | 7.4 |
| 5 | 157 | 217 | 374 | 45 | 1.2 | 8.4 | 7.5 | 4.3 | 6.6 |
| 6 | 55 | 424 | 479 | 233 | 4.9 | 2.3 | 9.6 | 7.2 | 5.7 |
| 7 | 60 | 364 | 424 | 152 | 3.6 | 2.8 | 8.5 | 6.0 | 5.2 |
| 8 | 23 | 12 | 35 | 17 | 4.9 | 2.9 | 0.7 | 2.8 | 4.0 |
| 9 | 45 | 9 | 54 | 13 | 2.4 | 3.3 | 1.1 | 1.7 | 2.2 |
| 10 | 3 | 23 | 26 | 0 | 0.0 | 2.3 | 0.5 | 0.3 | 1.1 |

As can be shown from Table A, topics that include a number of “Agree” votes that are similar in number to the “Disagree” votes are highly controversial, while other topics that include significant disparity between the number of “Agree” votes with respect to the “Disagree” votes are significantly less controversial.

Topics with a popularity rating above a particular threshold, such as, for example 7.5, are popular topics, while topics with a popularity rating below a particular threshold, such as, for example 2.5, are not popular topics. Topics with a high momentum rating are topics that have a relatively large number of comments that have been recently added as compared to the total number of comments for the topic. Top-rated topics tend to be topics with a high momentum rating, a high controversy rating, and a high popularity rating.

As shown FIG. in 14, system 100 can be hosted on a server 50 that includes a content database 51 and accessed over an electronic network 60, such as, for example, the Internet, by any known or as yet unknown method, including, but not limited to hardwired and wireless systems. A user can access system 100 via his/her own electronic device 52 such as, for example, a desktop computer. Alternatively, system 100 can be hosted on the user's own electronic device, removing the need for the network and host server.

Referring to flowchart 1500 in FIG. 15, in an exemplary embodiment, in order to use system 100, in step 1502, a first user transmits a first statement from electronic device 52, which is received by system 100. In step 1503, system 100 electronically publishes the first statement. In step 1504, system 100 electronically allows the first user to vote an opinion. In step 1505, system 100 electronically receives a comment from the first user after the first user has voted the opinion.

In step 1506, system 100 allows a second user to electronically vote an opinion regarding the validity of the first statement. In step 1507, system 100 uses the results of the second user's vote to determine a content value of the first statement.

After the second user votes his/her opinion, in step 1508 the second user transmits the first comment, which is generated in response to the first statement, which comment is received by system 100. In step 1510, system 100 electronically publishes the first comment with the first statement. In step 1511, system 100 allows any user to electronically vote an opinion regarding the first comment.

Optionally, in step 1512, the first user can transmit a second statement, which is received by system 100. The second statement and the first statement form an argument. In step 1514, system 100 analyzes the first statement and determines whether the argument is valid. If system 100 determines that the argument is not valid, in step 1516, system 100 further determines whether the argument constitutes a logical fallacy.

In step 1518, if system 100 determines that the first statement is similar to a prior statement, system 100 electronically links the first statement to the prior statement. Additionally, in step 1520, if system 100 determines that the first comment is related to a second statement, system 100 electronically publishes the first comment with the second statement.

In step 1521, system 100 electronically receives data. The data comprises profile information from the first user and from the second user and comprising a plurality of metrics. In step 1522, system 100 categorizes the first statement based on at least one of the plurality of metrics. In step 1524, the categorizing of the first statement comprises generating a rating value based on the categorizing. In step 1526, system 100 categorizes the first comment based on at least one of the plurality of metrics.

In step 1528, after the second user has voted on a predetermined plurality of statements, system 100 electronically provides recommendations to the second user as to how the second user should change existing votes or make new votes. In step 1532, system 100 allows a user to adopt the votes of a group or another user as their own.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A method comprising:
a. electronically receiving a first statement from a first user;
b. electronically publishing the first statement;
c. allowing a second user to electronically vote an opinion regarding the validity of the first statement; and
d. electronically receiving a second statement from the first user, the second statement and the first statement forming an argument.

2. The method according to claim 1, further comprising:
analyzing the first statement; and
determining whether the argument based on the first statement is valid.

3. The method according claim 2, further comprising determining whether the argument constitutes a logical fallacy.

4. The method according to claim 1, further comprising electronically receiving a first comment from a second user after the second user votes the opinion, the comment being generated in response to the first statement.

5. The method according to claim 4, further comprising electronically determining if the first comment is related to a second statement and, if so, electronically publishing the first comment with the second statement.

6. The method according claim 4, further comprising, after receiving the first comment from the second user, allowing at least one other user to electronically vote an opinion regarding the first comment.

7. The method according to claim 1, further comprising electronically publishing the first comment with the first statement.

8. The method according to claim 1, further comprising:
electronically receiving data, the data comprising profile information from the first user and from the second user and comprising a plurality of metrics; and
categorizing the first statement based on at least one of the plurality of metrics.

9. The method according to claim 8, wherein categorizing the first statement comprises generating a rating value based on the categorizing.

10. The method according to claim 8, further comprising categorizing the first comment based on at least one of the plurality of metrics.

11. The method according to claim 1, further comprising:
electronically receiving data, the data comprising profile information from the first user and from the second user and comprising a plurality of metrics; and
categorizing the first comment based on at least one of the plurality of metrics.

12. The method according to claim 1, wherein, subsequent to the second user voting on a predetermined plurality of statements, electronically providing recommendations to the second user as to how the second user should change existing votes or make new votes.

13. The method according to claim 1, further comprising:
electronically receiving data, the data comprising voting data and profile information from the first user and from the second user and comprising a plurality of metrics; and
calculating similarity between the users.

14. The method according to claim 1, further comprising using results of the vote to determine a content value of the first statement.

15. The method according to claim 1, further comprising electronically allowing the first user to vote an opinion.

16. The method according to claim 16, further comprising electronically receiving a comment from the first user after the first user has voted the opinion.

17. The method according to claim 1, further comprising allowing a user to adopt the votes of a group or another user.

18. A method comprising:
electronically receiving a first statement from a first user;
electronically publishing the first statement; and
electronically linking the first statement to a prior statement, the first statement substantially similar to the prior statement.

19. The method according to claim 18, further comprising, linking a second statement published in response to the prior statement to the first statement.

20. A non-transitory machine-readable storage medium, having encoded thereon program code, wherein, when the program code is executed by a machine, the machine implements a method comprising the steps of:
a. electronically receiving a first statement from a first user;
b. electronically publishing the first statement; and
c. allowing a second user to electronically vote an opinion regarding the validity of the first statement.
